(19) United States
(12) Patent Application Publication
(10) Pub. No.: US 2015/0102879 A1
(43) Pub. Date: Apr. 16, 2015

(54) WIRELESS ELECTRONIC DEVICE AND METHOD OF USE

(71) Applicant: Olio Devices, Inc., San Francisco, CA (US)

(72) Inventors: Steven Jacobs, San Francisco, CA (US); John McCarthy, San Francisco, CA (US); Evan Wilson, San Francisco, CA (US); Bruce Vest, San Francisco, CA (US)

(21) Appl. No.: 14/513,054

(22) Filed: Oct. 13, 2014

Related U.S. Application Data
(60) Provisional application No. 61/889,858, filed on Oct. 11, 2013.

(51) Int. Cl. H01F 7/06

(52) U.S. Cl. CPC H01F 7/06
USPC 335/294; 335/291

(57) ABSTRACT

A magnetic coupling system for electromagnetically connecting an electric device to a mounting system, including: a first interface comprising a first plurality of magnetic elements and a first induction coil defining a first central axis, the first interface connected to the electric device; and a second interface comprising a second plurality of magnetic elements and a second induction coil defining a second central axis, the second interface connected to the mounting system, wherein magnetic attraction between the first and second plurality of magnetic elements biases the first interface toward the second interface and transiently retains the first and second induction coils in a substantially coaxial relationship.

### CROSS-REFERENCE TO RELATED APPLICATIONS

This application claims the benefit of U.S. Provisional Application No. 61/889,858 filed 11 Oct. 2013, which is incorporated in its entirety by this reference.

### TECHNICAL FIELD

This invention relates generally to the wearable devices field, and more specifically to a new and useful wireless electronic device in the wearable devices field.

### BRIEF DESCRIPTION OF THE FIGURES

FIG. 1 is a perspective view of a variation of the magnetic coupling system including a first and second interface each including an induction coil and a plurality of magnetic elements, wherein electromagnetic attraction between the first and second plurality of magnetic elements biases the first interface toward the second interface and transiently retains the first and second induction coils in a substantially coaxial relationship.

FIG. 2 is a perspective view of a variation of an application of the magnetic coupling system, wherein the first interface is included in an electronic device and the second interface is included in a mounting system.

FIGS. 3-6 are cutaway schematic representations of a first, second, third, and fourth variation of the magnetic coupling system.

FIGS. 7A-12B are end-on schematic representations of a first, second, third, fourth, fifth, and sixth variation of the magnetic element groups, wherein the A figure depicts the magnetic element groups of the first interface and the B figure depicts the complimentary magnetic element groups of the second interface, respectively.

FIGS. 13A and 13B are end-on schematic representations of a variation of the magnetic coupling system wherein the first and second interfaces include a first and second induction coil, respectively.

FIGS. 14A-15B are end-on schematic representations of a first and second variation of the magnetic coupling system including electrical connectors, wherein the A figure depicts the first interface and the B figure depicts the second interface, respectively.

FIG. 16 is a cutaway schematic representations of a variation of the magnetic coupling system including magnetic element groups arranged perpendicular the coupling surfaces, wherein the first induction coil central axis is substantially coaxially aligned with the second induction coil central axis.

FIG. 17 is a cutaway schematic representation of a variation of an application of the magnetic coupling system, wherein the first interface is included in an electronic device and the second interface is included in a mounting system, wherein the first induction coil central axis is coaxially aligned with the second induction coil central axis.

FIG. 18 is a cutaway schematic representation of a variation of an application of the magnetic coupling system, wherein the first interface further includes a set of electrical connectors and is included in an electronic device, and the second interface further includes a set of electrical connectors and is included in a mounting system.

FIGS. 19 and 20 are cutaway schematic representation of a first and second variation of the electronic device.

FIGS. 21A, 21B, and 21C are schematic representations of a variation of an electronic device including mounting points, a charger including a power adapter, and the electronic device coupled to the charger, as seen from the charger coupling surface.

FIG. 22 is a cutaway schematic representation of an electronic device configured to couple to a watch mount, which, in turn, is configured to couple to a charger configured to inductively charge the electronic device.

FIGS. 23A, 23B, 23C, and 23D are end-on views of a variation of an electronic device display in a first orientation, an electronic device display in a second orientation, a watch mount, and the electronic device coupled to the watch mount.

FIG. 24 is a cutaway schematic representation of a variation of a magnetic coupling system including a set of alignment mechanisms.

FIG. 25 is a schematic representation of a variation of an electronic device coupling to a variation of a peripheral device.

FIG. 26 is a schematic representation of a second variation of an electronic device coupling to a second variation of a peripheral device.

FIGS. 27 and 28 are schematic representations of a first and second variation of the magnetic coupling system including a first and second variation of an alignment mechanism, respectively.

FIG. 29 is an exploded view of a variation of the electronic device including the first interface.

FIG. 30 is a perspective view of a variation of a magnetic element.

### DESCRIPTION OF THE PREFERRED EMBODIMENTS

The following description of the preferred embodiments of the invention is not intended to limit the invention to these preferred embodiments, but rather to enable any person skilled in the art to make and use this invention. For the purposes of the disclosure below, substantially can mean for the most part, essentially, and/or within a predetermined margin of error, such as within a manufacturing margin of error, user determined margin of error, or any other suitable margin of error.

### 1. Magnetic Coupling System

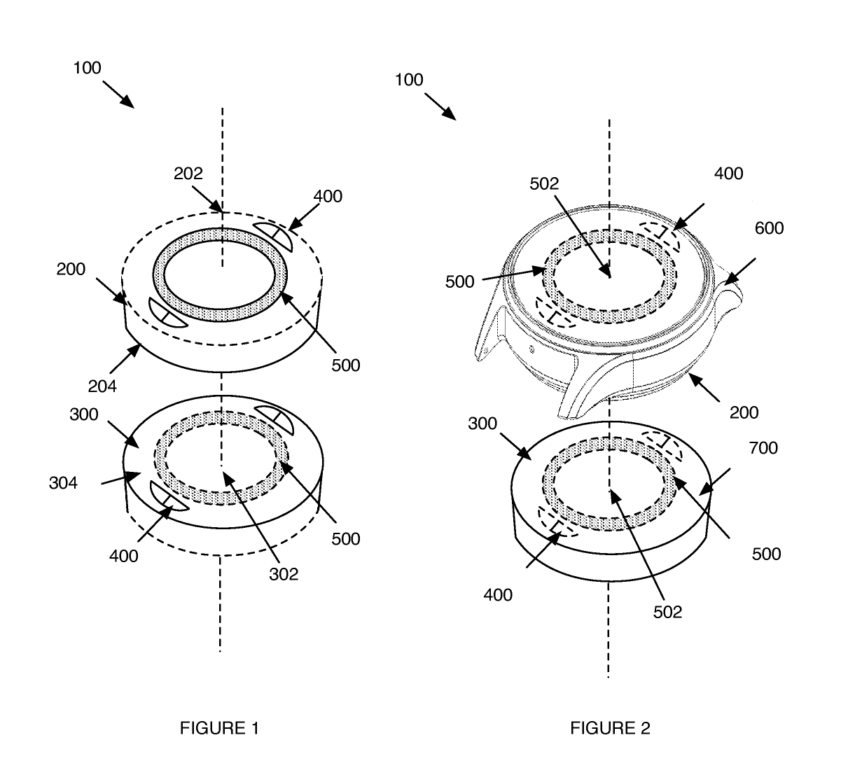

As shown in FIG. 1, the magnetic coupling system 100 preferably includes a first interface 200 that functions to transiently couple to a second interface 300. The first and second interface can additionally or alternatively function to couple to auxiliary interfaces. First and second interface coupling can additionally function to transiently retain a first interface position relative to a reference point on the second interface. More preferably, first and second interface coupling functions to align a first reference point 202 and second reference point 302 on the first and second interfaces, respectively. Alternatively, first and second interface coupling can align a first reference point 202 at a predetermined position relative to the second reference point 302, or otherwise position the first reference point 202.

This magnetic coupling system can confer several benefits over conventional systems. First, the magnetic coupling system generates a large normal retention force relative to the coupling interface, which can securely retain the first interface relative to the second interface and prevent first interface dislodgment in response to an applied normal force and/or bending moment. Second, the magnetic coupling system enables first interface removal from the second interface in response to application of a relatively small shear force or angular force, relative to the retention force. Third, the magnetic coupling system generates an attractive force, which can provide a user with tactile instructions for proper alignment, orientation, and/or coupling. Fourth, the magnetic coupling system can enable symmetric coupling (e.g., radially or rotationally symmetric coupling, reflection-symmetric coupling, point symmetric coupling etc.), such that the first interface can couple to the second interface in one or more orientations. Fifth, by controlling the radial and/or arcuate placement of the magnetic element sets on the first interface and second interface, the magnetic coupling system can radially align a point on the first interface with a point on the second interface. Sixth, the magnetic coupling system can function to arcuately orient a point on the first interface with a point on the second interface by using patterns of magnetic elements with alternating or opposing polarities. Seventh, by using the patterns of magnetic elements with alternating or opposing polarities 420, the magnetic coupling system can generate a highly concentrated magnetic field, which can function to increase the retention force, reduce electromagnetic interference with adjacent electromagnetic devices (e.g., credit cards), or otherwise influence the cooperatively generated magnetic field.

The magnetic coupling system is preferably operable between a retention mode and removal mode. In the retention mode, the magnetic coupling system can retain the relative coupled position of the first and second interfaces. The magnetic coupling system is preferably operable in the retention mode in response to application of a separation force up to a predetermined force threshold that is applied in a normal direction to the coupling surfaces of the first and second interface, but can alternatively be operable in the retention mode in response to any other suitable applied force. The predetermined force threshold is preferably approximately 1N, but can alternatively be between 0.8N and 2.2N (e.g., between 0.18 lb-force and 0.5 lb-force), or can be any other suitable force. In the removal mode, the first and second interfaces can be decoupled in response to a torsional force (rotational force) applied to the first or second interface in a direction perpendicular to the coupling surface normal vector, in response to relative rotation between the first and second interface, in response to a separation force exceeding the predetermined force threshold, or in response to any other suitable applied force. The minimum torsional force to switch system operation from the retention mode to the removal mode is preferably less than 0.8N, but can alternatively be between 0.8N and 2.2N (e.g., 1N), above 2.2N, or be any other suitable force.

In one variation, the interface is a sub-component of an electronic device, mounting system (e.g., inductive charger, peripheral device, etc.), or any other super-system, but can alternatively be a stand-alone component. In this variation, the interface can be arranged proximal a broad face of the super system (e.g., parallel a broad face of the super system, along a broad face of the super system, etc.), along a side of the super system, along an edge of the super system, or along any other suitable surface of the super system. In a second variation, the interface further defines a first and second broad face, wherein the magnetic elements can be arranged proximal a broad face of the interface (e.g., parallel the broad face of the interface, along the broad face of the super system, etc.), along a side extending between the first and second broad faces of the interface (e.g., as shown in FIG. 16), along an edge of the interface, or along any other suitable surface of the interface.

Each interface preferably includes a set of magnetic elements 402 that function to transiently retain, align, and orient the interfaces. Each interface can additionally include an induction coil 500 or any other suitable component that can benefit from substantially accurate alignment. Each interface preferably defines a coupling surface 204, 304 configured to couple to a complimentary interface. The coupling surface can be substantially planar, curved, or have any other suitable configuration. The coupling surface is preferably substantially smooth, but can alternatively or additionally include gripping features (e.g., traction, rubber, etc.), alignment features, or any other suitable feature. The interface can additionally define a central axis. The interface can include one or more axes of symmetry, but can alternatively be asymmetric. For example, the interface can be reflectionally symmetric, radially symmetric, point symmetric, or otherwise symmetric. In a specific example, the interface can have a substantially round broad face or perimeter, ovular broad face or perimeter, polygonal broad face or perimeter, an asymmetric broad face or perimeter, or any other suitable broad face or perimeter.

The magnetic elements 402 of the magnetic coupling system function to cooperatively generate an electromagnetic coupling force (e.g., an attractive force) that removably retains the first interface (e.g., an electronic device) with the second interface (e.g., a mounting system). The magnetic elements can additionally function to radially align a first reference point of the first interface with a second reference point of the second interface. The magnetic elements can additionally function to arcuately orient a third reference point 208 of the first interface relative to a fourth reference point 308 of the second interface. The first and third reference points and second and fourth reference points can be different or the same. The first and second reference points can be a central interface axis, central component axis such as an induction coil central axis (e.g., coil winding axis, etc.), a keying point on the interface perimeter, an exposed electrode, terminal, or other electrical connection, and/or be any other suitable reference point. The central axis preferably extends along a substantially normal axis to an interface coupling surface, but can alternatively extend at any other suitable angle to the interface coupling surface. The third and fourth reference points can be an axis of symmetry, a point along an interface perimeter, a predetermined display orientation, or any other suitable reference point. In one example, the first and second reference points can be arranged along the body of the interfaces, and the third and fourth reference points can be arranged along a perimeter of the interface.

The magnetic elements are preferably arranged in sets, wherein each set preferably includes a plurality of magnetic elements, but can alternatively include a single magnetic element. Each interface can include one or more sets of magnetic elements. Alternatively, each interface can include a plurality of magnetic elements, wherein the plurality of magnetic elements can be divided into one or more sub-sets. However, the magnetic elements can be otherwise organized into groups 400.

The magnetic elements 402 can be permanent magnets 403, electropermanent magnets 404, electromagnets, or any other suitable ferrous element. The permanent magnet can be made from a soft or hard ferromagnetic material. Examples of permanent magnet materials include iron, nickel, cobalt, rare earth metal alloys, annealed iron, alnico and ferrite, but any other suitable ferromagnetic materials can be used. The electropermanent magnet can include a static magnet, a reversible magnet, and a set of electrical solenoids disposed relative to the reversible magnet (e.g., disposed about the reversible magnet perpendicular to the static or reversible magnet magnetic field direction) and configured to dynamically adjust the reversible magnet polarity. The static magnet can be made of a hard ferromagnetic material (e.g., ferrite) and the reversible magnet can be made of a soft ferromagnetic material (e.g., alnico). However, the static and reversible magnets can be made from any other suitable material. The static and reversible magnets can be arranged such that the respective magnetic fields are oriented in the same direction in a first operating mode, and oriented in different directions in a second operating mode. In the second operating mode, the static and reversible magnets can be arranged with opposing magnetic fields, perpendicular magnetic fields, or magnetic fields in any other suitable pattern. The resultant magnetic field magnitude in the first operation mode is preferably larger than the resultant magnetic field magnitude in the second operation mode, but can alternatively be equal or smaller. The magnetic field magnitude of the static magnet can be larger than, substantially equal to, or smaller than the magnetic field magnitude of the reversible magnet.

The magnetic element strengths (e.g., resultant magnetic field magnitudes) of the magnetic elements can be substantially equal, can vary within a group, can vary between groups of an interface, can vary between interfaces, or can vary in any other suitable manner. The magnetic elements can be selected such that each magnetic element generates an electromagnetic field 180 having a magnitude of less than a tesla (e.g., 12.5 kG), such as on the order of a millitesla (e.g., 5 mT or 50 G), but can alternatively generate a magnetic field having a higher or lower magnitude. Alternatively, the magnetic elements within a group can be selected to have a net electromagnetic field less than a Tesla (e.g., 12.5 kG), such as on the order of a millitesla (e.g., 5 mT or 50 G), but can alternatively be selected to generate a net electromagnetic field having a higher or lower magnitude. The magnet strengths and configuration can additionally be selected to interact with the inductive charger to increase power receipt efficiency, adjust the magnetizing field resulting from charger operation, or otherwise interact with the inductive charger properties. In one variation of the system, the magnetic elements of each group are selected to generate a predetermined resultant coupling force between the first and second interfaces. The predetermined coupling force can be approximately 1N (0.25 pound force), between 0.8N and 2.2N (e.g., between 0.18 lb-force and 0.5 lb-force), or can be any other suitable force.

Each magnetic element group 400 preferably includes an even number of magnetic elements, which can be preferable to reduce the number of potential or partial coupling states, but can alternatively include an odd number of magnetic elements. In one variation, each magnetic element group includes only two magnets. In a second variation, each magnetic element group includes only three magnets. However, the magnetic element groups can include any suitable number of magnetic elements. The magnetic element groups on the same interface preferably have the same number of magnetic elements, but can alternatively include different numbers of magnetic elements. The magnetic element groups on the first and second interfaces preferably have the same number of magnetic elements (e.g., the first and second plurality of magnetic elements both have the same number of magnetic elements), but can alternatively have different numbers of magnetic elements (e.g., the first plurality of magnetic elements has a first number of magnetic elements, and the second plurality of magnetic elements has a second number of magnetic elements different from the first number). However, the groups can include any suitable number of magnetic elements.

The magnetic elements 402 within a group 400 are preferably arranged adjacent each other, but can alternatively be distributed about the interface. The magnetic elements of a group are preferably substantially contiguous with one or more of the other magnetic elements within the group (e.g., physically connected, partially connected, or separated by a small distance on the order of several millimeters or centimeters), but can be separated by a large gap or otherwise arranged. The magnetic elements can be arranged in a series (e.g., a line, with all magnetic elements in the group aligned along a shared axis or chord, a curve, with all magnetic elements in the group aligned along the curve, etc.), in a triangle, square, circle, or in any other suitable configuration. When the magnetic elements are arranged in a series (e.g., as shown in FIGS. 6A and 6B), the magnetic elements can be arranged with a vector extending through a series center aligned at a predetermined angle relative to a radius from a central axis of the respective interface. For example, the magnetic elements can be arranged in a line, and arranged with the line perpendicular to a radius extending from a central axis of the respective induction coil or respective interface (e.g., along a tangent to the radius).

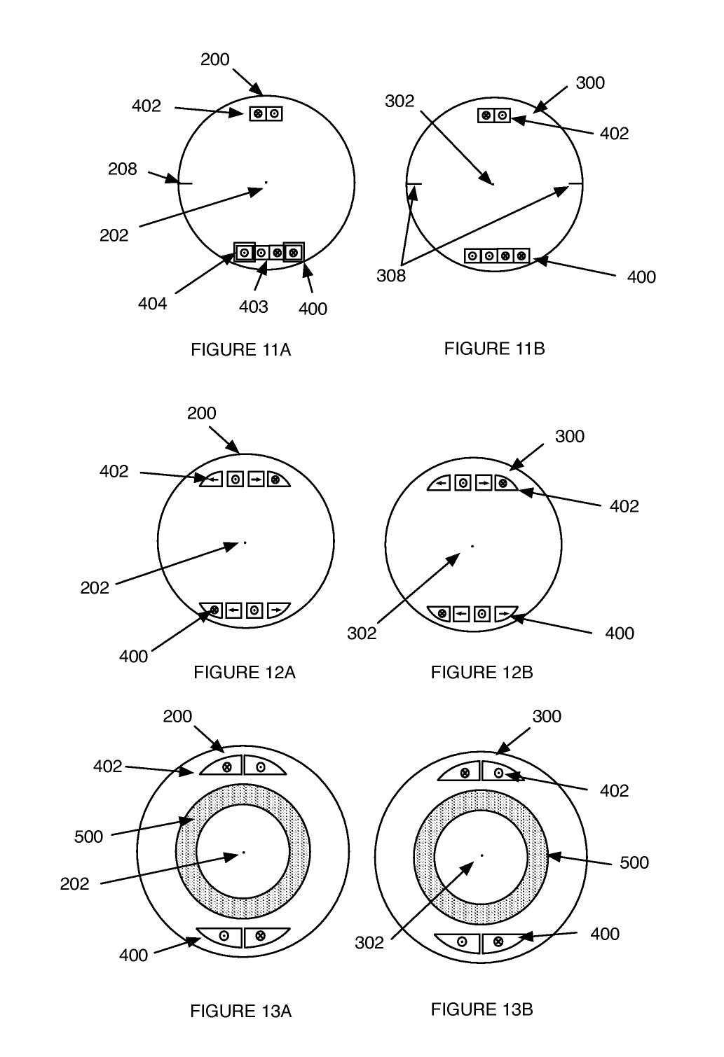

Each group 400 of magnetic elements 402 (e.g., set, plurality, sub-set, etc.) is preferably arranged with adjacent magnetic elements having misaligned polarities, wherein a first magnetic element can be oriented with the respective magnetic field directed in a direction different from the magnetic field orientation of an adjacent magnetic element. Alternatively, the group can include one or more adjacent magnetic elements with magnetic fields oriented in the same direction (e.g., as shown in FIG. 11B), or include any other suitable polarity pattern. Alternatively, the group can be split into magnetic element subsets (e.g., as shown in FIG. 11A), each subset including one or more magnetic elements, wherein the magnetic elements within each magnetic element subset can be collectively treated as a single magnetic element. The magnetic element groups can be arranged such that the net electromagnetic field is perpendicular the coupling surface, more preferably directed toward the coupling surface (e.g., external the interface or super system), but can alternatively be directed parallel the coupling surface, at an angle to the coupling surface, or in any other suitable direction.

In a first variation, the magnetic elements in a group 400 can be arranged with alternating magnetic fields, wherein each successive magnetic element in the group is arranged with a magnetic field polarity opposing that of the adjacent magnetic element to form an alternating pattern of magnetization (e.g., as shown in FIGS. 7A and 7B). The magnetic field of a first magnetic element is preferably directed in a first direction, and the second magnetic field of a second magnetic element adjacent the first is preferably directed in a second direction opposing the first. The first and second directions are preferably perpendicular an axis shared between the first and second magnetic elements, but can alternatively be parallel the shared axis or arranged in any other suitable angle relative to the shared axis. In a specific example, the first and second directions are perpendicular to a broad face of the respective interface. However, the first and second directions can be parallel to the broad face of the respective interface, at an angle to the broad face, or arranged in any other suitable orientation relative to the respective interface.

In a second variation, as shown in FIGS. 12A and 12B, the magnetic elements of a group 400 form a Halbach array, wherein adjacent magnetic elements in the array form a spatially rotating pattern of magnetization. The resultant magnetic field can be directed toward the exterior surface of the interface, such that the magnetic field of the magnetic elements of the first interface are directed toward the second interface when coupled, and the magnetic field of the magnetic elements of the second interface are directed toward the first interface when coupled. However, the resultant magnetic field can be directed along a vector perpendicular to an interface broad face, at an angle to the interface broad face, or in any other suitable direction. The magnetic elements of a group can be alternatively arranged in any other suitable pattern to induce any other suitable magnetic field.

A group 400 can be composed of magnetic elements of substantially the same type (e.g., all permanent magnets, all electropermanent magnets, etc.), material, strength and/or any other suitable parameter. In one variation of the system, the group is composed of substantially the same magnetic element arranged in a first and second orientation about a reflection axis to form the alternating polarity pattern. In this variation, the magnetic element is preferably asymmetric in a plane perpendicular to the magnetic field to enable simpler manufacturing and assembly (e.g., as shown in FIG. 30), but can alternatively be asymmetric in any other suitable plane, or be substantially symmetric. The magnetic element is preferably arranged with the asymmetric plane parallel to the coupling surface of the respective interface (e.g., as shown in FIGS. 7A and 7B), such that the magnetic field is directed perpendicular the coupling surface, but can alternatively be arranged in any other suitable orientation. In a specific example of an asymmetric magnetic element, the magnetic element includes a first and second opposing broad face arranged substantially perpendicular to the magnetic field direction, wherein the first and second broad face are substantially parallel to the asymmetric plane. The first and second broad faces can have isometric profiles, wherein the first broad face profile can be a reflection of the second broad face profile. The profile can include a first edge adjoining a second edge at a substantially normal at a first and second end of the first and second edges, respectively, and a curved profile connecting the opposing ends of the edges. However, the magnetic element can be otherwise configured.

Alternatively, the group 400 can be composed of magnetic elements of different types, different materials, different strengths, and/or having any other suitable variant parameter. When the group is formed from magnetic elements having different parameters, the different magnetic elements can be evenly distributed about the group or unevenly distributed about the group. In one variation, the relative sizes and/or strength of the magnets in the set preferably decrease with distance away from the center magnet of the set, but can all be the same size or vary in any other suitable manner. In a second variation, a group includes electropermanent magnets substantially evenly interspersed between adjacent permanent magnets. In a third variation, as shown in FIG. 11A, a group includes electropermanent magnets arranged along the distal ends of the series, with the permanent magnets in the center. In a fourth variation, a group includes electropermanent magnets arranged distal the interface external surface, across the permanent magnets, such that the electropermanent magnets are behind the permanent magnets. However, the magnetic elements within a group can be otherwise arranged and distributed.

The magnetic element groups 400 of the same interface are preferably substantially similar, having similar magnetic element types, arrangements, polarity patterns, numbers of magnetic elements, net magnetic field strength, or any other suitable parameter, but can alternatively be substantially different. In one variation, an interface can include multiple magnetic element groups, wherein each magnetic element group includes the same number of permanent magnets (e.g., two) having the same magnetic strength arranged in the same arrangement (e.g., in a line tangential to a radius extending from the reference point) and polarity pattern (e.g., opposing polarities, with a first magnetic element generating a magnetic field with a first direction arranged on the left, and a second magnetic element generating a magnetic field with a second opposing direction arranged on the right). In this variation, the magnetic element group arrangement on the interface can render the interface radially symmetric (rotationally symmetric, such as when the same polarity pattern direction is used and the groups are evenly arcuately distributed about the reference point), or radially asymmetric (e.g., when unevenly arcuately distributed, when different polarity pattern directions are used, etc.). In a second variation, an interface can include multiple magnetic element groups, wherein each magnetic element group includes the different numbers of permanent magnets (e.g., a first and second group having two and three magnetic elements, respectively) capable of cooperatively generating electromagnetic fields of different strengths and/or directions (e.g., a first and second magnitude in a first and second direction, respectively) arranged in the different arrangements (e.g., wherein the first group is arranged in a line tangential to a radius extending from the reference point and the second group is arranged in a diamond) and polarity pattern (e.g., opposing polarities and a Halbach array, respectively). However, the magnetic element groups of each interface can have any other suitable composition.

The magnetic element groups of each interface can be substantially evenly distributed about the interface coupling surface, or unevenly distributed. The magnetic element groups of each interface can be arranged with the respective common magnetic element axes at the same angle relative to a tangent extending from the reference point, at different angles relative to a tangent extending from the reference point, or in any other suitable configuration. The magnetic element groups of each interface can be positioned at substantially the same radial distance from the reference point, or be positioned at different radial distances from the reference point.

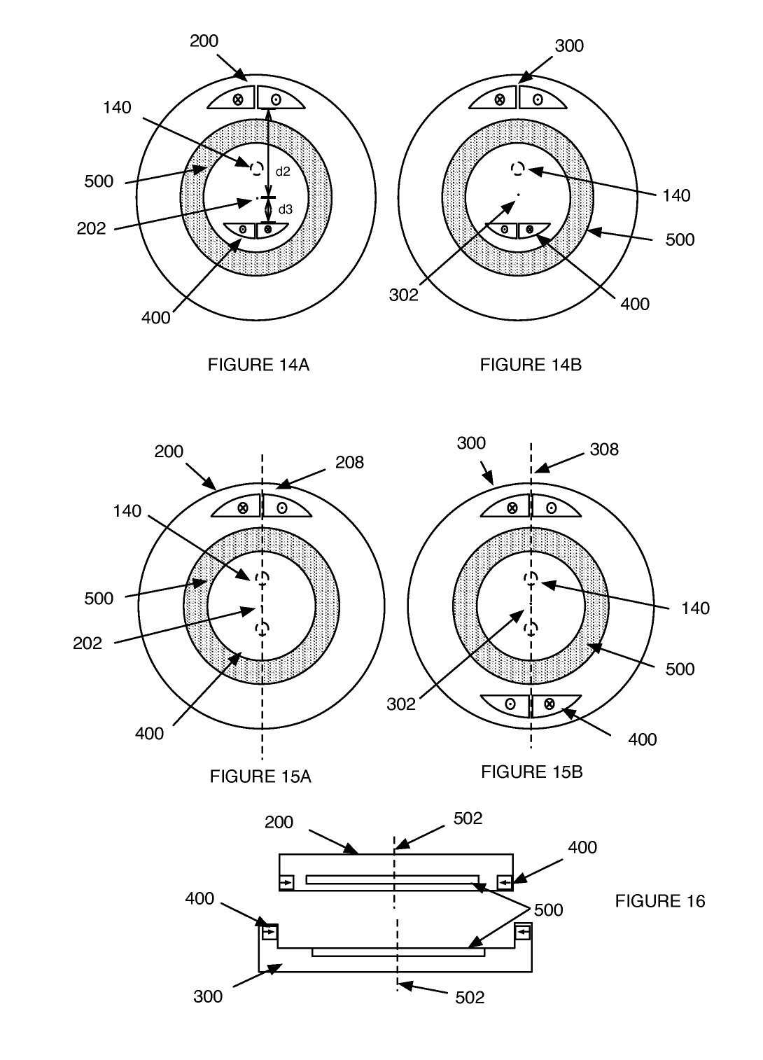

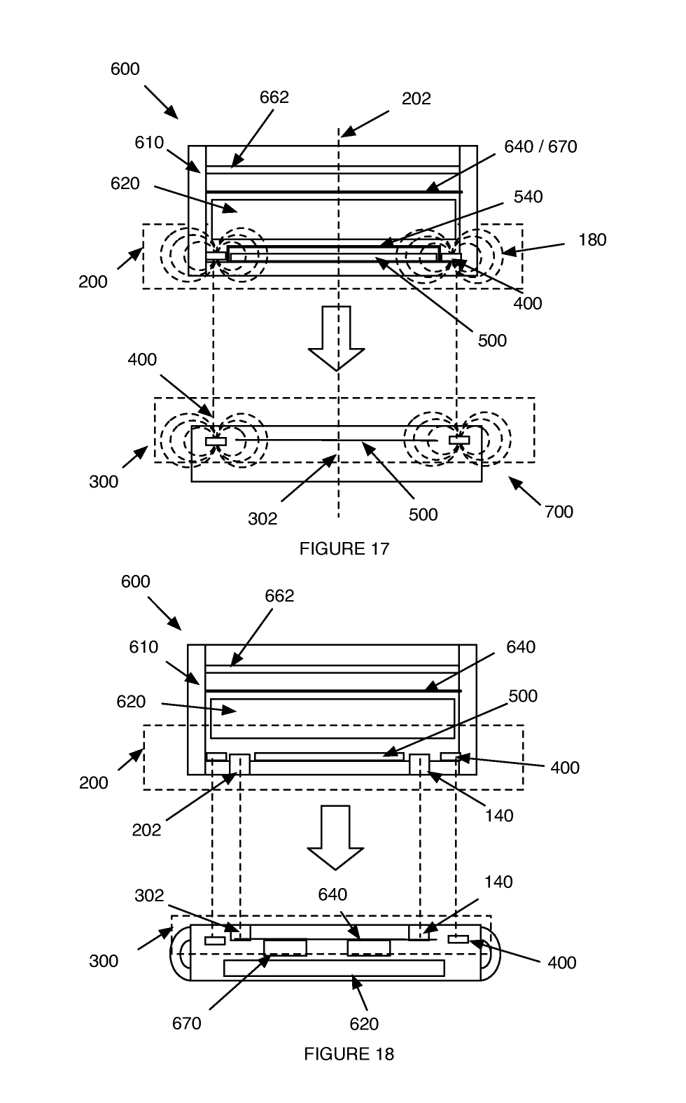

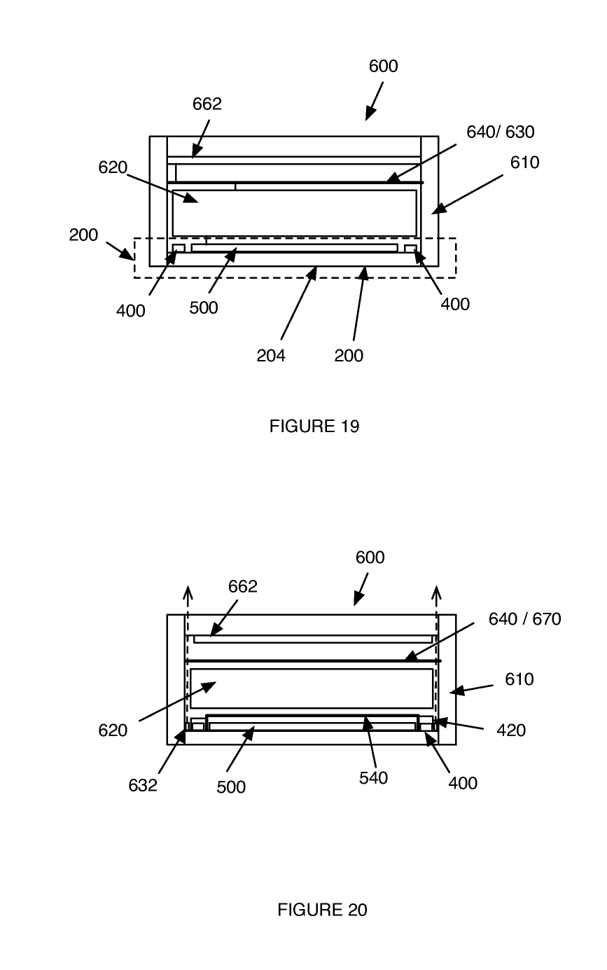

In one example, the magnetic element groups of an interface can be radially opposed along a chord (e.g., diametrically opposed across the reference point), wherein the magnetic element groups can be arranged equidistant from the reference point (e.g., d₁) or at different radial distances from the reference point (e.g., d₂,d₃). In a second example, the magnetic element groups of an interface can be evenly arcuately distributed about the reference point, wherein the magnetic element groups can be arranged equidistant from the reference point or at different radial distances from the reference point. In a third example, the magnetic element groups of an interface can be arranged at an angle to each other, wherein a first magnetic element group is arranged substantially parallel the coupling surface and a second magnetic element group is arranged along a wall extending from the coupling surface. However, the magnetic element groups can be otherwise arranged on the interface. In a specific example of the interface including a coil, the magnetic element groups can be arranged radially outward of the coil, as shown in FIGS. 13A and 13B. Alternatively, the magnetic element groups can be arranged radially inward of the coil, arranged with one or more magnetic element groups radially inward of the coil and one or more magnetic element groups arranged radially outward of the coil (e.g., as shown in FIGS. 14A and 14B), or arranged in any other suitable configuration.

As shown in FIGS. 7-15, the magnetic element groups of the first and second interfaces are preferably arranged in complimentary arrangements (e.g., both arranged in a line with substantially the same separation distance between adjacent magnetic elements) to the corresponding magnetic element group on the other interface, but can alternatively be arranged in different arrangements. The first and second interfaces can include the same number of magnetic element groups or a different number of magnetic element groups. The magnetic element groups are preferably arranged in complimentary positions relative to a first and second reference point to be aligned on the first and second interfaces (e.g., in the same arcuate and/or radial position, in a reflection of the complimentary group position, in a radially symmetric position, etc.), but can alternatively be arranged in different positions. The magnetic element groups of the first and second interfaces can be arranged equidistant from the reference point or arranged at different distances from the reference point. The positioning of one or more magnetic element groups of the second interface preferably mirror the position of one or more magnetic element groups of the first interface, relative to the reference point, but can alternatively be substantially different. In a specific example, the first interface includes a first magnetic element group and the second interface includes a second magnetic element group, wherein the first and second magnetic element groups are radially equidistant from a first and second reference point on the first and second interfaces, respectively. The first and second magnetic element groups can additionally be arcuately equidistant from a third and fourth reference point on the first and second interfaces, respectively, wherein the third and fourth reference points are preferably aligned in response to first and second interface coupling.

The magnetic element groups of the first and second interfaces preferably have complimentary patterns, such that one or more magnetic element groups of the first interface cooperatively generates an attractive electromagnetic force with one or more magnetic element groups of the second interface, but can alternatively have different patterns. The magnetic element groups of the first interface preferably cooperatively generates the substantially the same attractive electromagnetic force with each magnetic element group of the second interface, but can alternatively cooperatively generate different attractive and/or repulsive electromagnetic forces between a first and second magnetic element group subset of the second interface.

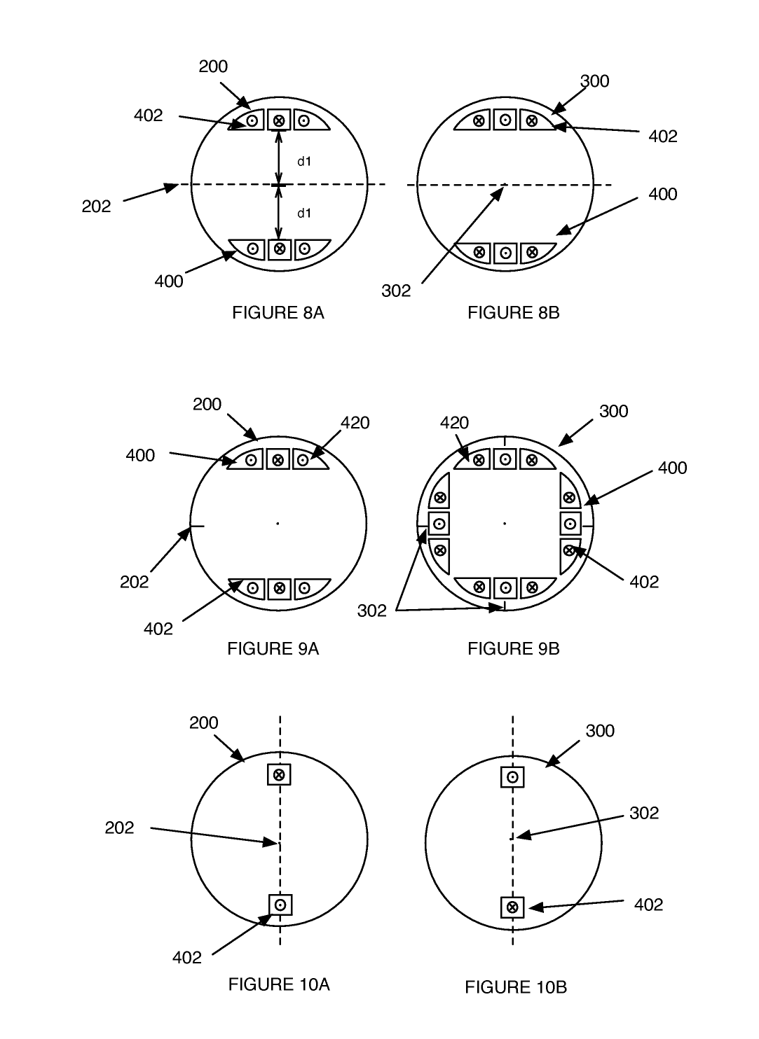

In one variation of the system as shown in FIGS. 8A and 8B, the first and second interfaces each include a single magnetic element group, wherein the magnetic element groups are each arranged an equidistant distance away from the respective reference points. In a specific example, the first and second reference points are the first and second central axes of the induction coil, respectively, wherein the first and second magnetic element groups are arranged a predetermined radius away from the respective central axis and at a predetermined angular position relative to the central axis or a secondary reference point.

In a second variation of the system as shown in FIG. 6, the first interface 200 includes a single magnetic element group 400 and the second interface 300 includes multiple magnetic element groups 400. Alternatively, the second interface can include a single magnetic element group, and the first interface can include multiple magnetic element groups. Alternatively, both the first and second interface can include multiple magnetic element groups, wherein the first and second interfaces can include the same number of magnetic element groups or different numbers of magnetic element groups. When an interface includes multiple magnetic element groups, the magnetic element groups of the interface can be evenly angularly distributed about the reference point, unevenly distributed about the reference point, equidistant from the reference point, arranged at variable radial distances from the reference point, or be arranged in any other suitable configuration. When an interface includes multiple magnetic element groups, the magnetic element groups can be distributed such that the interface includes an axis of symmetry (e.g., reflection axis), is radially symmetric, point symmetric, or otherwise symmetric. However, the magnetic element groups can be distributed such that the interface is asymmetric. Each magnetic element group in the first interface is preferably complimentary to (e.g., generate an attractive force with) each of the magnetic element groups in the second interface, but can alternatively be complimentary to a subset of the magnetic element groups in the second interface (e.g., one of multiple). Each magnetic element group in the first interface preferably generates the same coupling force with each magnetic element group in the second interface, but can alternatively generate a different coupling force with a first and second magnetic element group subset of the second interface. In a specific example, the magnetic element groups of the first and second interfaces have the same number of the same magnets arranged in the same configuration or pattern, and are arranged such that the first and second interfaces are radially symmetric.

In an example of the second variation, the first interface 200 includes a single magnetic element group and the second interface 300 includes a second and third magnetic element group, wherein the second and third magnetic element groups are arranged an equidistant distance away from the second reference point. However, the multiple magnetic element groups can be arranged different distances away from the second reference point or any suitable distance away from the second reference point. The second and third magnetic elements can function as keying or alignment points for the first interface. For example, if the first interface is radially symmetric, the second and third magnetic elements can be arranged at different angular positions. The first interface can couple to the second interface at a first angular position, as defined by the first magnetic element group coupling to the second magnetic element group, and a second angular position, as defined by the first magnetic element group coupling to the third magnetic element group. The second and third magnetic element groups can be diametrically opposed across the reference point (e.g., 180° apart along the second interface), but can alternatively be separated by any other suitable angular distance. This can function to limit or otherwise define the orientations in which the first interface can couple to the second interface, which can be useful if the first or second interface includes an orientation-dependent component, such as a display. In a specific example, if the first interface includes a display operable in a first and second opposing orientation, and the first magnetic element group is statically coupled to a known position relative to the first and second opposing direction, having the second magnetic element group arranged opposing the third magnetic element group can limit the number of coupling orientations to those that align the display with an external reference point (e.g., perpendicular a gravity vector, perpendicular an axis extending between two watch lugs, etc.).

In a second example of the second variation, the first interface 200 includes a first and second magnetic element group radially opposed across the first reference point of the first interface, and the second interface 300 includes a third and fourth magnetic element group radially opposed across the second reference point of the second interface, wherein the first and second magnetic element groups are both each complimentary to the third and fourth magnetic element groups.

In a third variation of the system, as shown in FIGS. 10A and 10B, the first interface 200 includes a first and second magnetic element having with opposing polarities, and the second interface 300 includes a third and fourth magnetic element having opposing polarities. The first magnetic element can cooperatively generate an attractive electromagnetic force with the third magnetic element, and cooperatively generate a repulsive electromagnetic force with the fourth magnetic element. The second magnetic element can cooperatively generate an attractive electromagnetic force with the fourth magnetic element, and cooperatively generate a repulsive electromagnetic force with the third magnetic element. The first magnetic element can be arranged opposing the second magnetic element across the reference point on the first interface, and the third magnetic element can be arranged opposing the fourth magnetic element across the reference point on the second interface, such that the first and second interfaces couple in a single orientation. However, the first and second interfaces can have any suitable number of magnetic element groups arranged in any suitable configuration.

The magnetic element groups of the first and second interfaces can additionally include one or more shunt plates 420 that function to concentrate or otherwise shape the electromagnetic field generated each magnetic element group (e.g., as shown in FIGS. 4 and 20). Alternatively, the interface can exclude a shunt plate. In one variation, each group can include a separate shunt plate. In a second variation, each interface includes a shunt plate for multiple groups. In a third variation, each magnetic element includes a separate shunt plate. However, the system can include any suitable number of shunt plates. The shunt plates are preferably ferromagnetic, but can alternatively be conductive, non-ferrous, or have any other suitable property. The shunt plates can be metallic (e.g., iron, alnico, steel, copper, etc.), polymeric, or made of any other suitable material. The shunt plates are preferably arranged distal and opposing the coupling surface across the magnetic elements (e.g., substantially parallel to the coupling surface), but can alternatively be arranged in any other suitable position. The shunt plate is preferably arranged with the magnetic element group magnetic field substantially perpendicular the shunt plate broad face, but can alternatively be arranged with the magnetic element group magnetic field substantially perpendicular to or at any other suitable angle relative to the shunt plate broad face. The shunt plate can be substantially planar, curved, angled, or have any other suitable configuration.

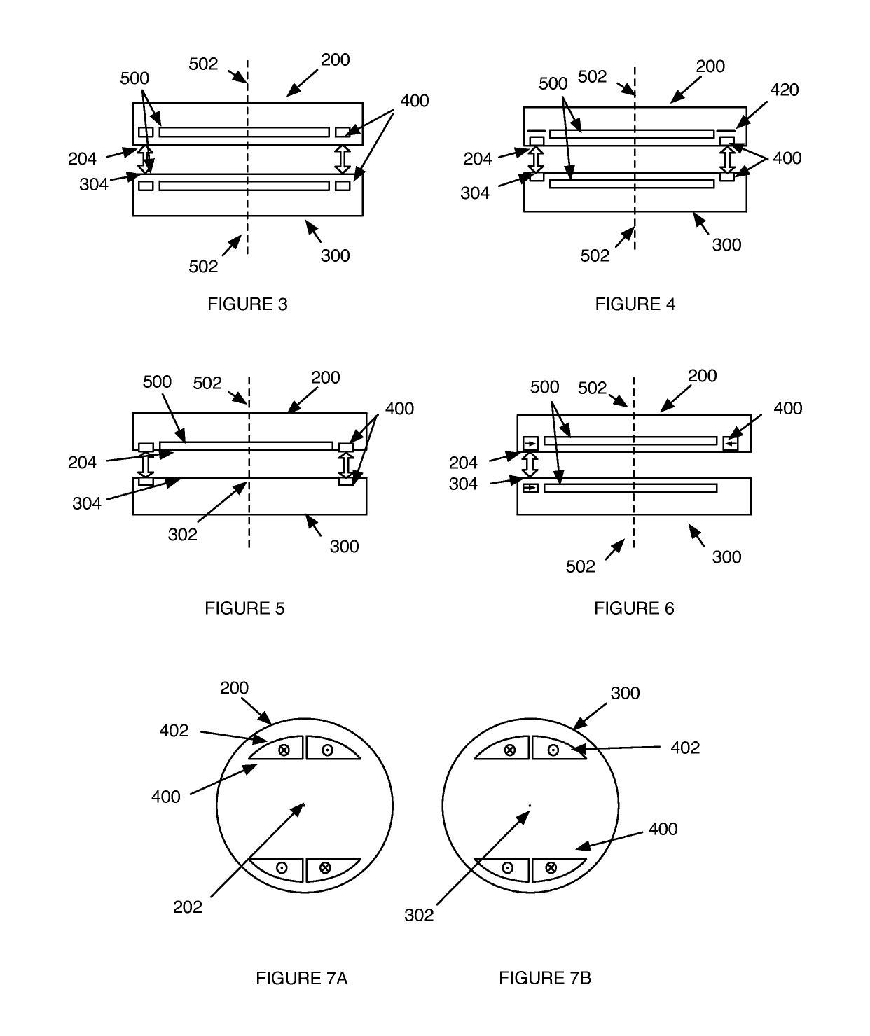

The induction coil 500 of the interface or super system functions to transfer (e.g., send or receive) energy through inductive coupling. The induction coil preferably includes one or more coils wound about a central axis (induction coil axis, winding axis, coil axis). The coil is preferably substantially planar and wound in a coil plane, but can alternatively be wound in a cylinder or otherwise configured. The coil is preferably arranged with the coil plane substantially parallel the coupling surface, but can alternatively be arranged with the coil plane perpendicular the coupling surface or at any other suitable angle relative to the coupling surface. The coil is preferably arranged proximal to the coupling surface, more preferably adjacent the coupling surface (as shown in FIG. 3, e.g., wherein a sealing material, such as glass or plastic is interposed between the coil and the coupling surface), but can alternatively be arranged along the coupling surface (e.g., as shown in FIG. 5) or arranged in any other suitable position relative to the coupling surface. The coil can be coaxially aligned with the interface or super system, arranged offset an interface or super system central axis or longitudinal axis, or be arranged in any other suitable configuration.

The induction coil 500 can be included in the first interface 200, the second interface 300, neither, or both. In the variation wherein the first and second interfaces include an induction coil, the induction coils are preferably tuned to resonate at substantially the same frequency to induce resonant inductive coupling. However, the induction coils can be non-resonant coupled inductors, wherein one or more of the inductive coils can additionally include a magnetic core or any other suitable coupling circuitry.

The induction coil 500 can have any suitable combination of wire gauge, number of windings, length, pitch, material, inductance, resistivity, capacitance, or any other suitable variable. In one specific example, the one or more induction coils can be a copper coil having a 28 mm outer radius, 16 mm inner radius, 19 turns, 0.25 mm sheet thickness, 0.53 mm total thickness, approximately 19 μH inductance (e.g., 18.78 μH), 0.72 ohm resistance, and 16.64 C charge capacity. However, the one or more induction coils can have any suitable combination of variables.

When multiple induction coils 500 are included in the interface or super system, the multiple coils can be substantially similar or different. The multiple coils can have substantially similar or different combinations of coil variables. The multiple coils can be concentric, offset (e.g., as determined by the respective coil axes), arranged in substantially the same plane, arranged in different planes (e.g., layered), or otherwise arranged. Including multiple coils in the interface can function to accommodate different induction coil resonant frequencies, different complimentary coil positions, or have any other suitable functionality. Alternatively, the interface or super system can include a single coil with a variable inductor in series with the coil, or accommodate for different resonance frequencies or arrangements in any other suitable manner.

The induction coil 500 can additionally be electrically connected to a power conversion circuit 520 that functions to convert a first power input to a second power output. In a first variation, the induction coil functions to provide an electromagnetic field. In this variation, the induction coil can additionally include a power adapter electrically connected to the power conversion circuit and configured to accept power from a power source, such as a power grid, renewable energy system (e.g., solar system, fuel cell, etc.) or any other suitable system. The power conversion circuit functions to convert power received by the power adapter into power for the induction coil. In a second variation, the induction coil functions to receive power. In this variation, the power conversion circuit can function to convert power received by the induction coil into power suitable for an electronic device or a power storage device (e.g., battery unit). However, the induction coil can additionally include any other suitable component.

The induction coil 500 can additionally include a flux concentrator 540 (flux intensifier, diverter, controller) that electromagnetically shields super system (e.g., electronic device) electronics (e.g., processing module) from the magnetic flux of the inductive charger, an example of which is shown in FIG. 20. Flux concentrator materials include laminations, pure ferrites, iron- and ferrite-based compositions, or any other suitable ferrous or otherwise magnetic material. The flux concentrator is preferably a shield that substantially encloses the inductive charger in cooperation with the electronic device casing, but can alternatively be a coating, sheet, envelope, or have any other suitable configuration. The flux concentrator is preferably arranged between the induction charger and the electronic component (e.g., distal and opposing the coupling surface across the coil), but can alternatively be arranged in any other suitable position.

Each interface of the magnetic coupling system 100 can additionally include an alignment mechanism 120 (shear prevention mechanism) that functions to prevent interface misalignment or shear movement relative to the complimentary interface. More preferably, the alignment mechanism prevents interface movement parallel to the coupling surface when coupled to the complimentary interface. The alignment mechanism is preferably substantially static, but can alternatively be operable between an extended and a retracted mode, or operable between any other suitable state. The alignment mechanism is preferably in the retracted mode when the interface is not coupled to the complimentary interface, and is preferably in the extended mode when the interface is coupled to the complimentary interface. The alignment mechanism preferably switches from the retracted mode to the extended mode in response to receipt of an extension force (e.g., an attractive force generated between the alignment mechanism and the complimentary interface, such as a magnetic force), and preferably switches from the extended mode to the retracted mode in response to removal of the extension force (e.g., retracts when a recovery spring force exceeds the attractive magnetic force). In one variation, the alignment mechanism can include a first group of weak magnetic elements that function to align the first interface relative to the second interface, wherein the first interface can additionally include a second group of strong magnetic elements along the coupling surface that function to retain the first and second interfaces (e.g., as shown in FIG. 27). The alignment mechanism of the interface is preferably complimentary to the alignment mechanism of the complimentary interface, but can alternatively be independent from the complimentary interface. The alignment mechanism can be a groove that receives a complimentary protrusion on the complimentary interface (e.g., as shown in FIG. 28). The groove preferably traces all or a portion of the perimeter of the interface back plate or broad face, but can alternatively be located at one or more discrete points along the interface broad face. The groove is preferably substantially smooth, but can alternatively be threaded, dimpled, or include any other suitable coupling feature. The alignment mechanism can alternatively be a protrusion that inserts into a complimentary groove on the complimentary interface. The protrusion preferably traces all or a portion of the perimeter of the interface back plate or broad face, but can alternatively be located at one or more discrete points on the interface. For example, the protrusion can be centered on the interface broad face, diametrically opposed across the interface broad face, evenly distributed about the interface edge, or otherwise arranged. The protrusion is preferably substantially smooth, but can alternatively be threaded, dimpled, or include any other suitable coupling feature. However, the interface can alternatively have an asymmetric profile, be configured to fit into a complimentary interface chamber or lumen (e.g., wherein the interface is entirely or partially encapsulated within the complimentary interface), or include any other suitable feature that aligns and maintains an interface position relative to the complimentary interface. Alternatively, the alignment mechanism can alternatively be a clip, screw, a lug or other protrusion, a groove or other indent, or any other suitable electronic device coupling mechanism. However, the alignment mechanism can include any suitable combination of the aforementioned alignment mechanism variations, or can include any other suitable alignment mechanism.

### 2. Specific Example

In a specific example of magnetic coupling system use, as shown in FIG. 2, the magnetic coupling system 100 electromagnetically connects an electronic device 600 to a mounting system 700, wherein the magnetic coupling system can include a first interface 200 connected to the electronic device 600 and a second interface 300 connected to the mounting system 700. The first interface 200 includes a first plurality of magnetic elements 400 and a first induction coil 500 defining a first coil central axis 502, and the second interface 300 includes a second plurality of magnetic elements 400. The magnetic coupling system functions to transiently retain, align, and orient the electronic device relative to the mounting system. More preferably, magnetic attraction between the first and second plurality of magnetic elements biases the first interface toward the second interface, and transiently retains the coil central axis relative to a reference point of the mounting system. The second interface can additionally include a second induction coil 500 defining a second central axis 502, wherein magnetic attraction between the first and second magnetic elements biases the first interface toward the second interface and transiently retains the first and second induction coils in a substantially coaxial relationship. However, the magnetic coupling system can transiently retain, align, and/or orient the electronic device in any other suitable manner.

The magnetic coupling system is preferably used to removably couple the electronic device to a mounting system, but can alternatively be used for any other suitable alignment application. The mounting system can be an inductive charger with an induction coil, but can alternatively or additionally be a watch mount including a first and second watch lug, a peripheral device, or any other suitable mounting system. When the mounting system is an inductive charger including an induction coil, the magnetic coupling system functions to substantially coaxially align the induction coil of the electronic device with the induction coil of the induction coil (e.g., within a margin of error, such as several millimeters), such that power transfer efficiency between the two coils can be maximized, optimized, or otherwise increased. Alternatively, the mounting system can substantially align a first and second angular portion of the first and second induction coils, respectively. When the mounting system is a watch mount, the magnetic coupling system can function to angularly align the electronic device with a reference point on the watch mount, such that an axis of a subsequently displayed image can be reliably aligned relative to the watch lugs. When the mounting system is a peripheral device, the magnetic coupling system can function to angularly align an axis of a subsequently displayed image on the electronic device with a reference point on the peripheral device (e.g., a longitudinal axis, gravitational axis, etc.). This can be particularly useful when the electronic device and/or mounting system has one or more axes of symmetry. When the mounting system and electronic device include a first and second electrical connection, respectively, the magnetic coupling system can function to substantially align the first and second electrical connection.

a. Electronic Device.

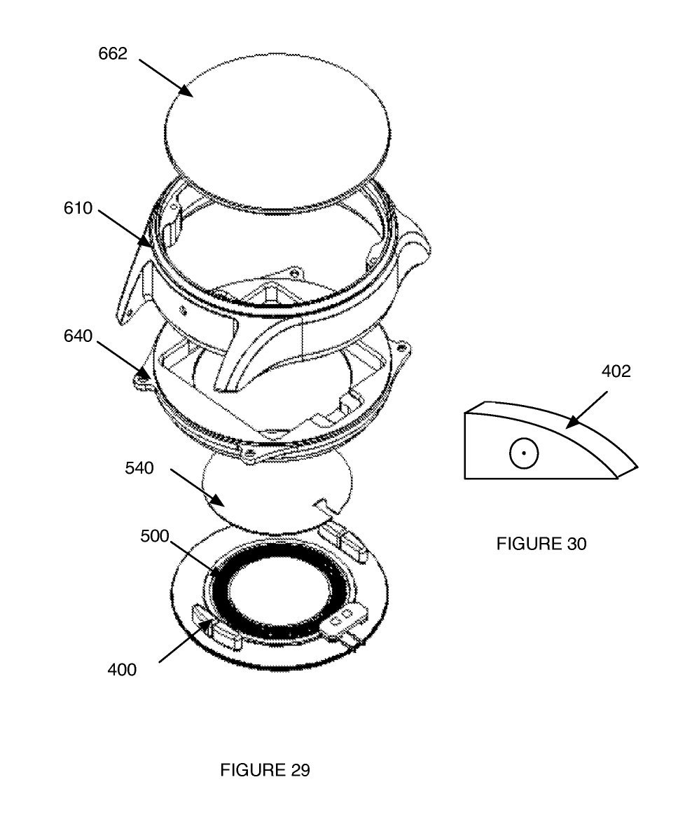

As shown in FIG. 29, the electronic device 600 includes a housing 610 (casing), and a first interface 200. The first interface 200 can include one or more groups of magnetic elements 400, and can additionally include a charging mechanism. The magnetic element groups can be any of the magnetic elements disclosed above, and can be passive or active. The charging mechanism is preferably a first induction coil 500, but can alternatively be a set of electrical connectors 140 or be any other suitable charging mechanism. The electronic device 600 can additionally include a power source 620, a communication module 630, a processing module 640, a display module 660, a sensing module 670, and/or any other suitable component. The electronic device can function as a personal identifier for a user, as a connection trigger for an auxiliary device, as a second display for the auxiliary device, as a portable computing device, or as any other suitable computing system.

The electronic device can be wirelessly coupled to (e.g., paired with) a portable computing device of the user, wherein the electronic device can receives operation data from the portable computing device. The electronic device can additionally or alternatively be wirelessly or physically connected to an auxiliary device, wherein the auxiliary device can have additional functionalities beyond the capabilities of the electronic device.

The electronic device 600 provides several benefits over conventional second screen systems, such as smartwatches. First, the electronic device is easily decoupled from the user and can be wirelessly charged (e.g., inductive charging without electric contacts, charging through surface contacts, etc.), which facilitates fast and easy recharging. This charging habit is further reinforced by incorporating a secondary functionality, such as streaming music, into the charging docks (the auxiliary devices), which can increase user willingness to remove the electronic device from the mount and place the electronic device on the charging docks. Second, the electronic device functions as a unique user identifier and as a port into the user's portable device (e.g., phone), thereby enabling the user to answer calls, make payments, control connected devices, or control any other suitable portable device functionality without having to take out the portable device. Third, the electronic device is preferably substantially entirely enclosed and lacks ports, such that security is enabled through isolation. Fourth, because the electronic device relies on the portable device for a majority of the electronic device's functionality, the electronic device and portable device pair can function as a two-step verification system. In one variation, the electronic device is preferably inoperable after a threshold period of time after disconnection from the paired portable device. In another variation, the electronic device simply functions as an identifier for the portable device. If the electronic device is beyond a threshold distance of the portable device (e.g., when the electronic device is stolen), the electronic device will be operable, but any auxiliary device connected to the electronic device will not be able to access the portable device.

In use, the user wears the electronic device 600 by coupling the electronic device to the wearable mount, wherein the electronic device functions as a second screen for the computing device. In response to the user coupling the electronic device to the accessory device, the electronic device functions as a user indicator, more preferably as a computing device indicator, to initiate user-preferred functionalities on the accessory device. The user preferably removes the electronic device from the wearable mount to physically couple the electronic device to the accessory device, but can alternatively touch or bring the mounted electronic device proximal the accessory device to digitally couple the electronic device to the accessory device. The electronic device can be charged when physically coupled to the auxiliary device. Data can additionally be communicated between the electronic device and auxiliary device through low-power, short-range communication when the electronic device is physically coupled to the auxiliary device, electrical contact pairs, or through any other suitable data communication means.

The electronic device 600 can be operable between a set of modes, dependent upon whether the electronic device is coupled to a mounting system. The electronic device can additionally be operable between the set of modes based on which mounting system the electronic device is mounted to. The electronic device is preferably operable between at least a standby mode and an active mode, and can additionally be operable in one or more auxiliary modes when the electronic device is connected to an auxiliary device. The electronic device is preferably operable in the standby or active modes when the electronic device is coupled to the mounting system, but can be operable in the standby or active modes when the electronic device is decoupled from the wearable mount or in any other suitable coupling state. The standby mode can include running low-power functionalities, running only the functionalities required to detect an adjustment event, shutting off, or operating in a low-power consumption state relative to the active mode in any other suitable manner. The active mode can include powering the display module, receiving data from the portable device and/or the auxiliary device, recording measurements from the sensors at an increased frequency, sending data (e.g., sensor measurements, etc.) to the portable device and/or auxiliary device, or operating in a high-power consumption state relative to the standby mode. However, the standby and active modes can include running any suitable functionality. The electronic device is preferably switched from the standby mode to the active mode in response to the detection of an adjustment event. The adjustment event is preferably based on sensor measurements, but the electronic device operation mode can alternatively be switched when an adjustment signal is received from the portable device or the auxiliary device. The electronic device operation mode can be switched based on accelerometer measurements, wherein the electronic device is operated in the active mode in response to an accelerometer signal indicative of a normal vector of the electronic device broad face falling within a predetermined angular range of the gravity vector (e.g., when the angle between the normal vector and the gravity vector is less than) 60°. The electronic device operation mode can be switched based on a touch sensor measurement, wherein the electronic device is operated in the active mode in response to a detected touch (e.g., a change in screen capacitance or resistivity, etc.), such as a tap. The electronic device can be operated in the active mode in response to receipt of a predetermined touch pattern (e.g., a pattern of two taps). In one example, the electronic device can include a piezoelectric chip that generates a current that initiates the wakeup sequence in response to an applied force (e.g., a user pressing on the electronic device). The electronic device operation mode can be switched based on transducer measurements, wherein the electronic device is operated in the active mode in response to a transducer signal indicative of a predetermined audio pattern. The audio pattern can be a pattern of audio generated by the user (e.g., whistling), generated by mechanical contact with the electronic device (e.g., tapping), or generated by any other suitable means.

The electronic device 600 can additionally be operable in a different auxiliary operation mode for each different mounting system. The electronic device can automatically determine which mounting system it is connected to based on information or power transfer, or lack thereof, between the mounting system and the electronic device, based on the components (e.g., induction coil only, electrical contact only, induction and electrical coil, etc.) that are electrically coupled to the mounting system, or based on any other suitable mounting system identifier. In one example, the electronic device can be operable in a first auxiliary operation mode in response to electronic device coupling to a first mounting system, operable in a second auxiliary operation mode in response to electronic device coupling to a second mounting system, and operable in a third auxiliary operation mode in response to electronic device coupling to a third mounting system. The first, second, and third mounting systems can be mounting system types (e.g., wearable mount, peripheral device, or charger), or can be individual mounting systems (e.g., a first and second wearable mount, etc.). The standby and active modes can be shared or different across different auxiliary operation modes. In one example, the electronic device can be operable in a first auxiliary operation mode in response to electronic device coupling to a wearable mount (e.g., a watch band), operable in a second auxiliary operation mode in response to electronic device coupling to a charging device, and operable in a third auxiliary operation mode in response to electronic device coupling to a peripheral device, wherein each auxiliary operation mode can be associated with a different set of electronic device functionalities. In this example, the electronic device can function as a smartwatch and/or interface to the personal device in the first auxiliary operation mode, as an electronic device power storage unit state of charge indicator in the second auxiliary operation mode, and as a peripheral device control interface in the third auxiliary operation mode. However, the electronic device can be operable in any other suitable set of operation modes.

The casing 610 (housing) of the electronic device functions to mechanically protect and enclose the electronic device components. The casing can define a first and second opposing broad face and a central axis extending substantially perpendicular the first and second broad face. The first and second broad faces can have the same dimensions or have different dimensions. The first and second broad faces can be rotationally symmetric, reflectionally symmetric, include one or more axes of symmetry, be asymmetric, or have any other suitable symmetry. The first and/or second broad face can be circular, ovular, polygonal, or have any other suitable profile. The casing can be cylindrical, prismatic, pyramidal, spherical, or have any other suitable shape. However, the casing can include any other suitable configuration.

The casing 610 preferably substantially cooperatively encloses all of the electronic device components with the display cover. Alternatively, the electrodes or electronic connectors can extend through the casing, and are preferably flush with the casing exterior but can alternatively protrude or be recessed from the casing. The casing is preferably formed from siding and backing, but can alternatively include a unitary housing, wherein the housing defines the electronic device sides and back face. Alternatively, the casing can include any suitable number of pieces. The casing is preferably metal, but can alternatively be plastic (e.g., polymeric), cloth, stone, wood, carbon fiber, or any other suitable material. In a specific example, the casing includes a first and second electromagnetically translucent broad face, with a set of electromagnetically opaque walls extending between the first and second broad face. The first and second broad face can include glass or plastic, and the walls can include metal or any other suitable material. The casing can additionally include mounting points, such as watch lugs, rings, clips, or any other suitable mounting point.

The transition between the wall and a broad face (e.g., the second broad face) can be smooth (e.g., curved), angled (e.g., include a right angle, obtuse angle, etc.), stepped (e.g., include multiple angled transitions between the wall and broad face), as shown in FIGS. 22 and 29, or have any other suitable transition. The transition can additionally function as an alignment mechanism for the first interface. The casing can additionally include the alignment mechanisms, wherein the alignment mechanisms can be arranged along the broad face supporting the first interface, but can alternatively be arranged along any other suitable casing surface. The casing can additionally define the reference points for magnetic element group alignment. The casing can additionally include receptacles that function to align and retain the magnetic elements relative to the casing.

The first interface 200 of the electromagnetic device functions to substantially align the induction coil with a reference point on the mounting system 302. The reference point 302 is preferably a second induction coil, but can alternatively be an axis of symmetry or any other suitable reference point. In a specific example, the first interface substantially coaxially aligns the first induction coil with the second induction coil. The first interface is preferably the first interface as described above, wherein the first interface can include one or more groups of magnetic elements. The first interface can additionally include an induction coil, wherein the induction coil can be coaxially aligned with the casing central axis or offset from the casing central axis. The first interface is preferably arranged along the second broad face of the casing, but can alternatively be arranged along a wall of the casing or along any other suitable surface of the casing. The first interface can form the second broad face of the casing, such that the coupling surface is the second broad face, be arranged proximal the second broad face of the casing (e.g., such that the first interface is interposed between the second broad face and the mounting system), or arranged in any other suitable configuration. The components of the first interface can be enclosed within the casing, be separate from the casing, extend through the casing thickness and protrude from or be flush with the second broad face, or be otherwise arranged relative to the second broad face.

The power source 620 functions to power the electronic device components. The power source is preferably a secondary cell (rechargeable battery), but can alternatively be a primary cell. The power source is preferably charged by the charging module. The power source can be CR2032 batteries, LR44 batteries, or have any other suitable form factor. The power source is preferably a lithium ion battery, but can alternatively be a nickel cadmium battery, a polymer-based battery, rechargeable alkaline battery, a zinc-bromine battery, or any other suitable battery chemistry. The electronic device preferably includes a single battery, but can alternatively include multiple batteries, wherein each of the multiple batteries can cooperatively power a single power sink, or can individually power different power sinks (e.g., chips). The power source is preferably electrically connected to the induction coil, and can additionally be electrically connected to all or a subset of the powered components of the electronic device (e.g., the communication module, processor, display, etc.).

The communication module 630 functions to send and receive data between the electronic device and the portable device and/or auxiliary device. The communication module preferably includes a short-range communication technology, but can alternatively or additionally include a long-range communication technology. The communication module can include one or more communication technologies. The communication module preferably includes a receiver, and can additionally include a transmitter. The receiver and transmitter can be for the same technology (e.g., paired), or can be for different technologies. The communication module technology can be Bluetooth, ANT+, cellular, infrared, NFC, RFID, Wi-Fi, Z-Wave, or any other suitable communication technology. The electronic device can additionally include one or more chips (e.g., a BodyCom™ chip) that enable intra- and inter-body communication by coupling to the user's body (e.g., through capacitive coupling) and using the body as a transmission medium. The communication module can include one or more antennas 632 that function to communicate information. In a specific variation, as shown in FIG. 20, the antenna is substantially concentrically arranged relative to the induction coil, wherein the antenna can be radially arranged external the induction coil or radially arranged internal the induction coil. In this variation, the electronic device can include an electromagnetic gap between the display and the wall, wherein the antenna can be substantially aligned with the gap and transmit information through the gap. However, the antenna can be arranged on the exterior surface of the electronic device or in any other suitable position of the electronic device.

The display module 660 functions to render graphics. The graphics can be received from the portable device, retrieved from storage on-board the electronic device, generated by the electronic device, or received from the auxiliary device. Examples of graphics that can be displayed include an image (e.g., an image of a clock rendering the instantaneous time), video, text (e.g., email), navigation indicators (e.g., an arrow, list of directions, etc.), a skin (e.g., background), or any other suitable graphic. The display module preferably includes a display 662, a display cover, and a graphics processor. The display can be an LED display, an OLED display, a LCD display, a plasma display, or any other suitable digital display. The display cover is preferably translucent, more preferably transparent, and can be glass, plastic, mineral composition (e.g., sapphire), or any other suitable material. The display is preferably a touch display, more preferably a capacitive touch display but can alternatively be any other suitable display or data input system. The graphics processor is preferably integrated within the processing module, but can alternatively be a separate graphics chip. The display is preferably arranged along the first broad face of the casing, opposing the first interface. However, the display can be arranged in any suitable position relative to the casing.

In a first variation, the display 662 is operable in a single position relative to the casing, wherein the magnetic element groups of the first and second interfaces can be configured to retain the casing in a predetermined position relative to the mounting system, such that the display is oriented in a predetermined position when the electronic device is coupled to the mounting system. In this variation, the display position functions as the third reference point. In a specific example of this variation, the display is operable in a single arcuate position relative to the casing, such that the top of the displayed image is fixed relative to a third reference point radially outward of the first reference point, such as on the casing perimeter (e.g., aligned with the third reference point, a predetermined angular distance away from the third reference point). The magnetic element group(s) of the first interface are arranged a predetermined arcuate distance from the display arcuate position or the third reference point. The mounting system can include a fourth reference point radially outward of the second reference point, such as on the mounting system perimeter, wherein electronic device preferably couples to the mounting system such that the top of the displayed image is a fixed distance from the fourth reference point (e.g., aligned with the fourth reference point, a predetermined angular distance away from the fourth reference point, etc.). The arcuate distance between the magnetic element group(s) of the second interface and the predetermined display alignment on the mounting system or the fourth reference point can be substantially the same as the predetermined arcuate distance between the magnetic element groups of the first interface and the display arcuate position or the third reference point, such that coupling between the magnetic elements of the first and second interface substantially angularly align the display at the desired position on the mounting system. In a specific example, the top of the display position forms a third reference point 666 to be aligned with a fourth reference point on the mounting system, and the central axes of the casing and mounting system form the first and second reference points, respectively. The first and second interface can each include a single complimentary magnetic element group, wherein the magnetic element group of the first interface is arranged a first radial distance from the first reference point, along a radius extending between the first and third reference points, and the magnetic element group of the second interface is arranged the first radial distance from the second reference point, along a radius extending between the second and fourth reference points. In a second specific example, the first and second interface includes a first and second opposing magnetic element group, wherein the first magnetic element groups are attracted to each other and repulsed from the second magnetic element groups. The first magnetic element groups are arranged a first radial distance from the first and second reference points, along radii extending between the first and third reference points and the second and fourth reference points, respectively. The second magnetic element groups are arranged a second radial distance from the first and second reference points, along a radius extending between the first reference point and a point diametrically opposed to the third reference point, and a radius extending between the second reference point and a point diametrically opposed to the third reference point, respectively. However, the magnetic elements can be otherwise arranged to retain the display position relative to a mounting system reference point.

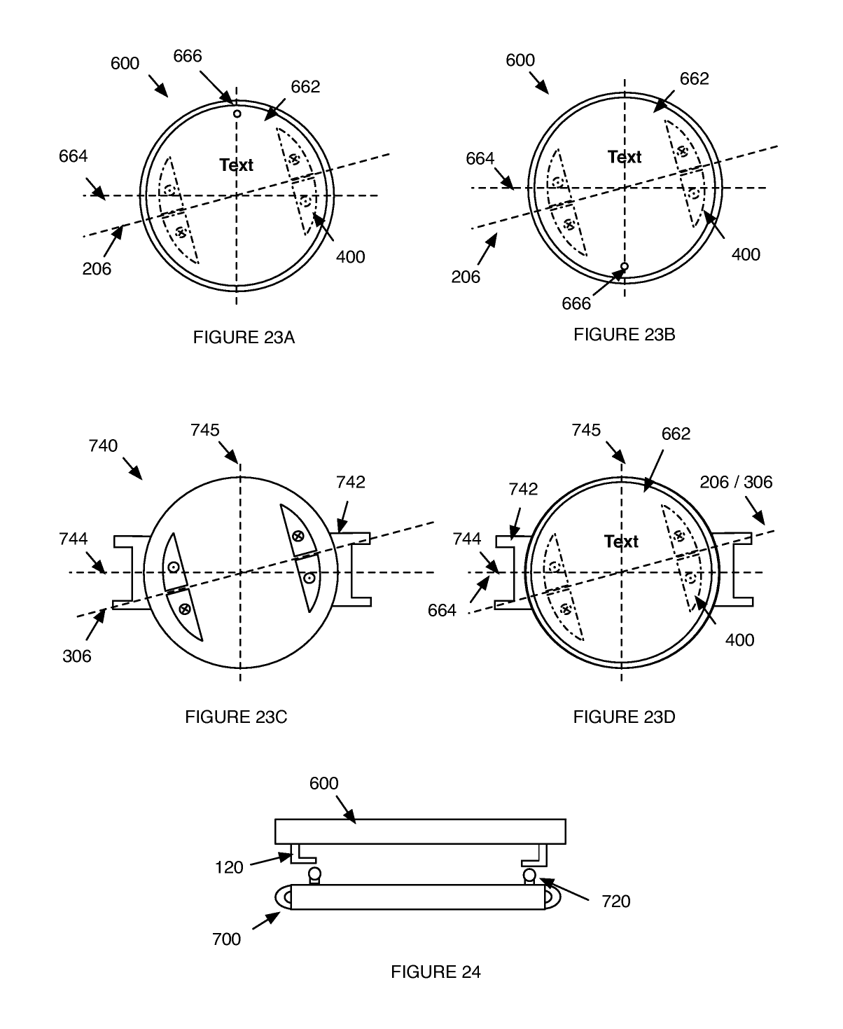

In a second variation, an example of which is shown in FIGS. 23A and 23B, the display is operable in a first and second opposing position, wherein the first and second opposing positions are opposed across an axis of symmetry. The first and second opposing positions are arcuately fixed relative to the casing, and the axis of symmetry or the axis along which the first and second positions are opposed can function as the third reference axis. The mounting system includes a fourth reference axis, wherein the third reference axis is preferably aligned with the fourth reference axis when the electronic device and mounting system are coupled. The magnetic elements of the first and second interfaces are preferably arranged substantially the same radial and arcuate distances from the third and fourth reference axes, respectively. In a specific example, the first and second interfaces can include a pair of rotationally symmetric magnetic element groups, wherein the pairs are aligned along the third and fourth reference axes, respectively. In a second specific example, the first interface can include a single magnetic element group aligned along the third reference axis and the second interface can include a pair of rotationally symmetric magnetic element groups, complimentary to the first interface magnetic element group, that are aligned along the fourth reference axis. However, the magnetic elements can be otherwise arranged relative to the device display positions.

The electronic device 600 can additionally include an orientation mechanism that controls display orientation relative to a third reference point on the casing or an external reference point (e.g., gravity). The orientation mechanism can include an accelerometer, gyroscope, or any other suitable orientation mechanism. For substantially symmetric electronic devices, the direction for displayed content can be determined by the accelerometer or by the user (e.g., in response to a user mapping of the electronic device screen). Alternatively, the electronic device can automatically select a display orientation position based on which electronic connector is coupled, which magnetic element groups are coupled, or based on any other suitable orientation indicator.

The processing module 640 functions to perform the functionalities of the electronic device. Example functionalities include processing data from the portable device and/or auxiliary device into data suitable for display or use by the electronic device, processing received data into data suitable for display or use by the auxiliary device, receiving, processing, and storing sensor data, retrieving and sending stored data (e.g., media) for play, and receiving, processing, and sending user input data to the portable device and/or auxiliary device. The electronic device functionality or operation mode is preferably automatically selected based on a received auxiliary device identifier, but can alternatively be selected based on a signal from portable device or based on a signal received from a user. The processing module preferably includes a central processing unit (CPU) and digital memory (e.g., ram and/or flash).

The sensing module 670 functions to measure environmental parameters. More preferably, the sensing module functions to determine a user input through changes in the environmental parameter measurements. The sensing module can be incorporated into the processing module, or can be a separate system. The sensing module can include one or more sensors, such as an accelerometer, gyroscope, compass, light sensor, transducer (e.g., microphone), touch sensor (e.g., piezoelectric sensor), camera, altimeter, barometer, thermometer, magnetometer, or any other suitable sensor. The sensing module can additionally include an audio module, which preferably includes a microphone, such as an acoustic transducer, and an audio output, such as an audio output jack or a speaker. The sensing module can additionally include a motor that functions to generate vibration in response to determination of a notification event.

In one variation of the electronic device, the induction coil is arranged within the casing, proximal the back face. The induction coil preferably includes a flux concentrator substantially enclosing the induction coil against the interior of the back face. The electronic device coupling mechanisms, a set of magnet groups, are substantially evenly distributed about the back face perimeter, between the inductive coil charger and the electronic device edge. The power source (e.g., battery) is arranged proximal the induction coil, the processing module is arranged proximal the power source and distal the induction coil, and the display module is arranged proximal the processing module and distal the power source, with the display proximal the processing module and the display cover distal the processing module. The sensing module, audio module, or any other suitable circuitry is preferably arranged on the same circuit board as the processing module.

b. Mounting Systems.

The electronic device 600 is preferably removably couplable to each of a plurality of mounting systems 700, wherein the mounting systems 700 each include a complimentary interface (second interface 300). The plurality of mounting systems can each include the same second interface, or can include different complimentary interfaces (e.g., selected based on the mounting system functionality, desired electronic device orientation, desired number of different electronic device orientations, etc.). The mounting system preferably includes the second interface, wherein the second interface includes one or more magnetic element groups complimentary to the magnetic element groups of the first interface, and can additionally include a charging mechanism.

The mounting system 700 can define a first and second broad face, wherein the second interface can be arranged along the first broad face of the mounting system, be arranged on the side, or be arranged along any other suitable surface of the mounting system. The second interface can be enclosed within the mounting system, be arranged along the surface of the mounting system, form the broad surface of the mounting system, or be otherwise arranged relative to the mounting system.

The magnetic element groups 400 can be any of the magnetic elements disclosed above, and can be passive or active. The magnetic element groups can be arranged to be substantially electronic device orientation agnostic (e.g., symmetric about the mount), but can alternatively orient the electronic device in a set of discrete orientations (e.g., four different rotational orientations, one orientation, etc.).

The charging mechanism functions to provide power to the electronic device. The charging mechanism is preferably a second induction coil 500, wherein mounting system and electronic device coupling substantially coaxially aligns the first and second induction coil, but can alternatively be a set of electrical connectors or be any other suitable charging mechanism. The charging mechanism can be electrically connected to a power source or power adapter, wherein the power adapter is configured to removably couple to a power source. The power source can be a power generator, a power grid, a renewable source (e.g., fuel cell, solar panel system, etc.), or any other suitable power source. The charging mechanism can additionally include a power conversion circuit configured to convert power source power to power suitable for the electronic device.

The mounting system can additionally include a set of coupling features arranged on the first broad face. Examples of the coupling features include a lumen that receives the electronic device, a groove that receives an electronic device protrusion, a protrusion that inserts into a electronic device groove, a bar that receives a clip, or any other suitable coupling mechanism. The coupling features can additionally or alternatively include a high friction surface 702 configured to couple to a broad face of the electronic device, more preferably the back face (e.g., second broad face) of the electronic device. The high friction surface includes a rubberized coating, sandpaper coating, a coating that has a high affinity for the electronic device surface, a coating that generate van der Waals forces between the wearable mount surface and the electronic device surface, or any other suitable coating.

The mount coupling mechanism can additionally include a mount alignment mechanism 720. The mount alignment mechanism can be complimentary to the electronic device alignment mechanism, but can alternatively be independent of the electronic device alignment mechanism. The mount alignment mechanism is preferably passive, but can alternatively be active. Examples of alignment features include a protrusion that is complimentary to a groove on the electronic device, a groove that is complimentary to a protrusion on the electronic device, a first and a second opposing wall configured to bound and restrain the electronic device along a first axis, a casing that restrains a broad face of the electronic device (e.g., couples along the perimeter of the electronic device broad face to restrain the electronic device against the body of a user), and a casing that encloses the entirety of the electronic device. However, the coupling feature can include any suitable combination of the aforementioned coupling feature variations, or can include any other suitable coupling feature.

The mounting system can additionally include a communication module that functions to communicate information between the mounting system and electronic device. The communication module can be a WiFi module, NFC module, Bluetooth module, beacon module, IR module, or any other suitable communication module. In one variation, the communication module transmits a mounting system identifier to the electronic device. The electronic device preferably changes the electronic device operation mode in response to receipt of the mounting system identifier, but can alternatively maintain the previous operation mode. For example, the electronic device can operate in a watch mode when mounted to a watch mount, and operate in a necklace mode when mounted to a necklace mount.

The mounting system can additionally include one or more powered components that function to provide additional functionality to the electronic device. This can be particularly desirable when the mounting system is only used for certain types of activities, and the functionalities performed by the electronic device are specific to those activities. For example, a pressure sensor might only be desired for diving purposes, wherein the mounting system that converts the electronic device into a diving watch could incorporate a pressure sensor. This can additionally be desirable for applications that are inconvenient for electronic device wear, or for applications wherein the electronic device is detached from the mounting system (e.g., during charging periods). For example, the mounting system can include an accelerometer for sleep tracking or running. Including the auxiliary powered components in the mounting system can have the effect of reducing the size and complexity of the electronic device. The powered components can be powered by the electronic device (e.g., leverage the electronic device battery) or can be powered by an internal power source (e.g., power generator or battery). The powered components can include sensors (e.g., humidity sensor, temperature sensor, light sensor, pressure sensor, etc.), processors, display elements, active transmitters, active receivers, or any other suitable powered component. The signals generated by the powered components can be communicated to the electronic device through the power transmission and/or receipt mechanism, but can alternatively be communicated wirelessly or over a physical connection. The electronic device preferably adjusts the electronic device functionality based on the signals received from the mount. Alternatively, the powered component can include a user indicator that functions to notify a user. The powered component can include a motor, a heating element, a speaker, a pressure-generation mechanism (e.g., a pump), a light, a display, or any other suitable notification mechanism.

In one example, the plurality of mounting systems can include a wearable mount 740 (e.g., a watch band, necklace, etc.) configured to couple the electronic device to the exterior of a user's body. The wearable mount can be configured to couple to a user's wrist, but can alternatively couple to the user's neck, clothing (e.g., belt, pants, strap, shirt, etc.), wrist, ankle, torso, or any other suitable body part or extension of the user. The wearable mount can include one or more mounting points, such as a lug 742 removably couplable to a watch strap, a hook or eyelet removably couplable to a chain, a circlip, hairpin clip, or any other suitable mounting point. In a specific example, as shown in FIGS. 23A-23D, the wearable mount is a watch mount, wherein the electronic device can function as the watch face or watch body. The watch mount can include a body including a substantially planar base defining a first and second opposing broad face and a first and second watch lug 742 coupled to diametrically or radially opposed sides of the body. The watch body can additionally include walls extending at a non-zero angle from the first broad face. The watch mount can include a first axis of symmetry 744 extending through the first and second watch lug, and a second axis of symmetry 745 extending perpendicular to the first axis of symmetry. In a specific example, the display of the electronic device can be operable in a first and second opposing orientation, wherein the first and second orientations are opposed across a third axis of symmetry 664. The electronic device can be configured to couple to the watch mount such that the third axis of symmetry is substantially parallel to or aligned with the first axis of symmetry. The electronic device can include a first and second radially opposed magnetic element group aligned along a first chord 206, and the watch mount can include a third and fourth radially opposed magnetic element group aligned along a second chord 306. The distance between the first and second magnetic element groups can be substantially similar to the distance between the third and fourth magnetic element groups. The first and second magnetic element groups can be arranged with the first chord positioned a predetermined angular distance from the third axis of symmetry (e.g., normal to the third axis, 30° from the third axis, etc.) in a first rotational direction. The third and fourth magnetic element groups can be arranged with the second chord positioned the predetermined angular distance from the first axis of symmetry in a second, opposing rotational direction from the first rotational direction (e.g., normal to the third axis, 150° from the third axis, etc.), such that the second interface is a mirror image of the first interface. However, the magnetic elements can be otherwise arranged. The watch mount can additionally be thin enough such that the magnetic field of the magnetic element groups of the second interface penetrates through the second broad face, such that the watch mount can additionally couple the electronic device to an auxiliary device, such as an inductive charger. However, the wearable mount can be configured in any other suitable manner.

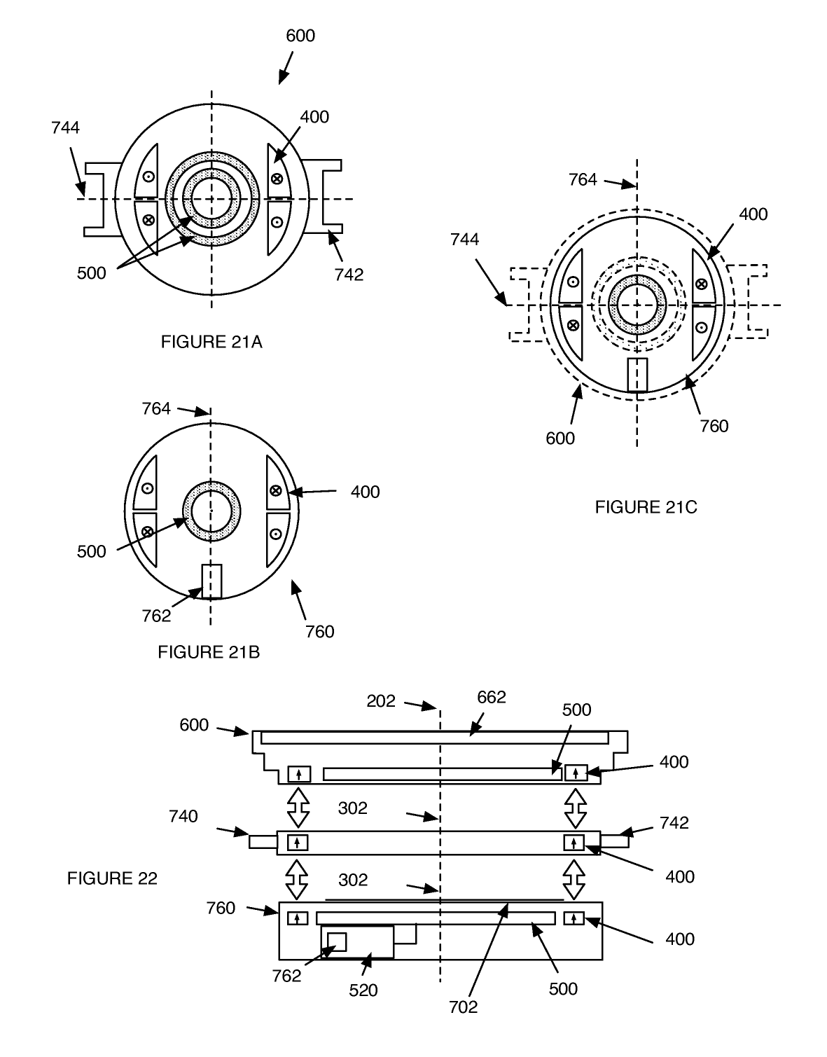

In a second example, the plurality of mounting systems 700 can include an inductive charger 760. The inductive charger can include a second induction coil and one or more magnetic element groups. The inductive charger can include a base and a charging surface opposing the base, wherein the second interface is arranged along the charging surface. The inductive charger can additionally include a power adapter 762. The power adapter can be arranged along a side of the inductive charger, at a non-zero angle to the charging surface. In a specific example, as shown in FIGS. 21A-21C, the power adapter is arranged perpendicular to the charging surface. The power adapter can be a cord, a female adapter including an opening defined along the inductive charger surface, or be any other suitable power adapter. The power adapter can be electrically connected to a power conversion circuit, which is electrically connected to the induction coil. The inductive charger can define a charger axis of symmetry 764 extending through the longitudinal axis of the power adapter. The electronic device and/or watch mount can be configured to couple to the inductive charger with the electronic device induction coil and inductive charger induction coil coaxially aligned and with the first axis of symmetry 744 (e.g., the axis of symmetry extending through the watch lugs) perpendicular the charger axis of symmetry, such that the watch lugs 742 do not interfere with the power adapter. In a specific example, the first and second magnetic element groups can be arranged with the first chord 206 positioned a predetermined angular distance from the first axis of symmetry (e.g., normal to the first axis, 30° from the first axis, etc.) in a first rotational direction. The inductive charger can include a third and fourth radially opposed magnetic element groups, both complimentary to the first and second magnetic element groups and aligned along a second chord 306. The third and fourth magnetic element groups can be arranged with the second chord positioned the predetermined angular distance from the chord axis of symmetry in a second, opposing rotational direction from the first rotational direction (e.g., normal to the third axis, 150° from the third axis, etc.), such that the second interface is a mirror image of the first interface. However, the inductive charger can be configured in any other suitable manner.

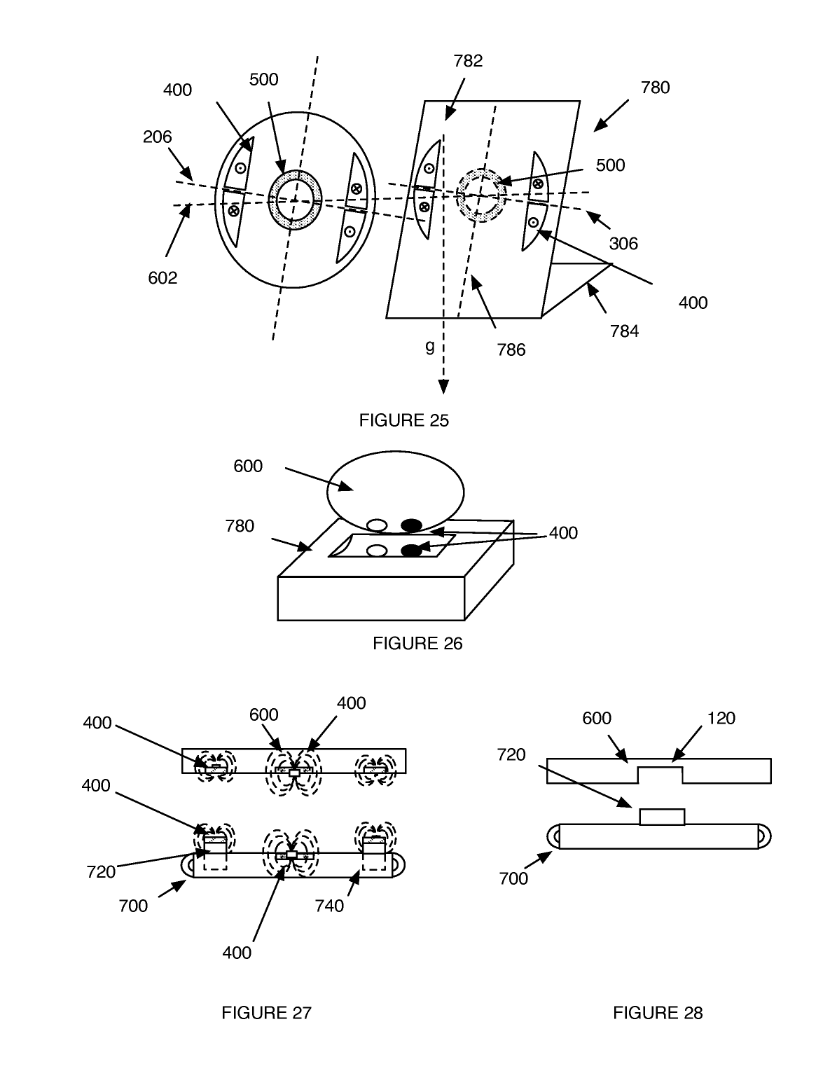

In a third example, the plurality of mounting systems 700 can include a peripheral device 780 (peripheral computing device) configured to operate in a first mode based on data received from the electronic device while the electronic device is digitally connected to the respective peripheral device. The peripheral device can additionally operate in a second mode when the electronic device is disconnected from the peripheral device. The peripheral device can include a processor, user output (e.g., display, speaker, etc.), user input (e.g., touchscreen, microphone, etc.), sensors, or any other suitable component. The peripheral device can include a power adapter such as that disclosed above, and/or can include a power storage unit, such as a battery. The peripheral device can include a mounting surface 782 substantially complimentary to the electronic device second broad face, wherein the second interface is arranged within or forms the mounting surface. The peripheral device can additionally include a resting surface 784 configured to rest upon a substrate surface (e.g., a table surface). The mounting surface can be arranged at a non-zero angle from the resting surface, or configured to rest on the substrate surface such that the mounting surface is substantially parallel to or at an angle to a gravity vector. Alternatively, the coupling surface can be configured to rest substantially perpendicular to the gravity vector. The peripheral device can include an axis extending perpendicular a mounting surface-resting surface interface, an axis formed by a reflection of the gravity vector on the mounting surface, or include any other suitable peripheral device alignment axis 786. In a specific example, as shown in FIG. 25, the display of the electronic device can be operable in a first and second opposing orientation, wherein the first and second orientations are opposed across a first axis of symmetry 6020. The electronic device can be configured to couple to the peripheral device with the first axis of symmetry arranged perpendicular the peripheral device alignment axis. The electronic device can include a first and second radially opposed magnetic element group aligned along a first chord 206, wherein the first chord can be positioned a predetermined angular distance from the first axis of symmetry (e.g., parallel the first axis, normal to the first axis, 30° from the first axis, etc.) in a first rotational direction. The peripheral device can include a third and fourth magnetic element group aligned along a second chord 306, wherein the second chord can be positioned the predetermined angular distance from a normal axis to the peripheral device alignment axis in a second, opposing rotational direction from the first rotational direction (e.g., normal to the third axis, 150° from the third axis, etc.), such that the second interface is a mirror image of the first interface. The peripheral device can additionally include a second inductive coil, wherein the third and fourth magnetic element groups are the same radial distance away from the second inductive coil central axis as the first and second magnetic element groups are away from the first inductive coil central axis. In a second specific example, as shown in FIG. 26, the peripheral device can include a trough configured to receive an edge of the electronic device, wherein the trough minima includes the second interface. In this example, the electronic device can include a first magnetic element group complimentary to those in the second interface arranged along an edge of the casing, such that a vector extending between the first magnetic element group and a casing central axis is perpendicular to the first axis of symmetry. However, the peripheral device can be configured in any other suitable manner.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. An electronic device transiently connectable to a mounting system, the electronic device comprising:
a housing having a first axis of symmetry and a first and second opposing broad face substantially parallel the first axis of symmetry;
an induction coil arranged proximal to and substantially parallel to the second broad face, the induction coil comprising a central axis;
a first magnetic element pair arranged proximal the second broad face; and
a second magnetic element pair arranged proximal the second broad face in radial opposition to and rotationally symmetric with the first magnetic element pair across the central axis, wherein an imaginary chord connecting the first and second magnetic element pairs is a predetermined angular distance from the first axis of symmetry, wherein each magnetic element pair comprises a first magnetic element having a first polarity directed normal to the second broad face and a second magnetic element having a second polarity directed normal to the second broad face, wherein the first polarity opposes the second polarity, wherein the second broad face is configured to transiently connect to a broad face of the mounting system, the mounting system comprising a third magnetic element set arranged proximal the broad face of the mounting system and configured to generate an attractive force with the first and second magnetic element pair in a direction substantially parallel to the central axis, and wherein magnetic attraction between the first or second magnetic element pair and the third magnetic element set biases the second broad face toward the second interface and transiently retains the central axis in a predetermined position relative to a reference point on the mounting system.

2. The electronic device of claim 1, wherein the first and second magnetic element pairs are substantially aligned with the first axis of symmetry.

3. The electronic device of claim 1, wherein the mounting system further comprises a second induction coil arranged parallel the broad face of the mounting system, wherein the reference point comprises a second central axis of the second induction coil, wherein magnetic attraction between the first or second magnetic element pair and the third magnetic element set retains the first and second central axes in a coaxial relationship.

4. The electronic device of claim 1, wherein the housing further comprises a first and second radially opposed watch lug substantially aligned with the first axis of symmetry.

5. The electronic device of claim 4, wherein the first imaginary chord is substantially normal to the first axis of symmetry.

6. The electronic device of claim 5, wherein the second interface further comprises a power connector arranged along a wall of the mounting system at a non-zero angle to the broad face of the mounting system, wherein the mounting system defines a second axis of symmetry extending parallel to the broad face of the mounting system, wherein the third magnetic element set is arranged substantially along the second axis of symmetry, wherein the third magnetic element set comprises a magnetic element pair comprising a first magnetic element having a first polarity directed normal to the broad face of the mounting system and a second magnetic element having a second polarity directed normal to the broad face of the mounting system, wherein the first polarity opposes the second polarity.

7. A magnetic coupling system for electromagnetically connecting an electric device to a mounting system, comprising:
a first interface comprising a first plurality of magnetic elements and a first induction coil defining a first central axis, the first interface connected to the electric device; and
a second interface comprising a second plurality of magnetic elements and a second induction coil defining a second central axis, the second interface connected to the mounting system; and
wherein magnetic attraction between the first and second plurality of magnetic elements biases the first interface toward the second interface and transiently retains the first and second induction coils in a substantially coaxial relationship.

8. The electronic device of claim 7, wherein each plurality of magnetic elements are arranged in a series of substantially contiguous magnets with adjacent magnets having misaligned polarities.

9. The electronic device of claim 8, wherein the first and second plurality of magnetic elements comprise an equivalent number of magnets.

10. The electronic device of claim 9, wherein each plurality of magnetic elements consists essentially of an even number of magnets.

11. The electronic device of claim 10, wherein each successive magnet in a plurality of magnets is arranged with a polarity opposing that of the adjacent magnet.

12. The electronic device of claim 8, wherein the first interface further comprises a third plurality of magnetic elements radially opposing the first plurality of magnetic elements across the first central axis and is rotationally symmetric with the first plurality of magnetic elements, wherein magnetic attraction between the third plurality of magnetic elements and the second plurality of magnetic elements biases the first interface toward the second interface and transiently retains the first and second induction coils in a substantially coaxial relationship.

13. The electronic device of claim 12, wherein the first and second pluralities of magnetic elements are equidistant from the first and second central axes, respectively.

14. The electronic device of claim 13, wherein the first and third pluralities of magnetic elements are equidistant from the first central axis of the first induction coil.

15. The electronic device of claim 13, wherein the second interface further comprises a fourth plurality of magnetic elements radially opposing the second plurality of magnetic elements across the second central axis and is rotationally symmetric with the second plurality of magnetic elements, wherein magnetic attraction between the first plurality of magnetic elements and the fourth plurality of magnetic elements biases the first interface toward the second interface and transiently retains the first and second induction coils in a substantially coaxial relationship.

16. The electronic device of claim 15, wherein the third and fourth pluralities of magnetic elements are equidistant from a first and second pluralities of magnetic elements.

17. The electronic device of claim 7, wherein each magnet of the system comprises a permanent magnet.

18. The electronic device of claim 17, wherein each magnet of the system has an asymmetric profile along a first and second axis, wherein the first axis is normal to the second axis.

19. The electronic device of claim 18, wherein each magnet comprises a first and second opposing broad face, wherein the magnets are arranged with the respective broad faces substantially perpendicular the respective central axis, wherein each magnet is configured with a magnetic field directed normal to the broad face, and wherein the magnet profile is symmetric about a third axis normal to the first and second central axes, wherein the third axis is parallel to the broad faces.

20. The electronic device of claim 7, wherein the first and second interfaces are substantially planar, wherein magnetic fields generated by the first and second pluralities of magnetic elements are directed normal to the first and second planar interfaces, respectively, wherein the first interface further comprises a shunt plate coupled to a broad face of the first plurality of magnetic elements distal the first interface.
